(19) United States
(12) Patent Application Publication
(10) Pub. No.: US 2024/0278653 A1
(43) Pub. Date: Aug. 22, 2024

(54) VEHICLE SYSTEM

(71) Applicant: HITACHI ASTEMO, LTD., Hitachinaka-shi, Ibaraki (JP)

(72) Inventors: Ryuhei TAKADA, Hitachinaka-shi (JP); Hideki SEKIGUCHI, Hitachinaka-shi (JP)

(73) Assignee: HITACHI ASTEMO, LTD., Hitachinaka-shi, Ibaraki (JP)

(21) Appl. No.: 18/563,964

(22) PCT Filed: Sep. 17, 2021
(86) PCT No.: PCT/JP2021/034385

§ 371 Date: Nov. 24, 2023

(51) Int. Cl. B60L 15/20

(52) U.S. Cl. CPC B60L 15/2054; B60L 15/2036; B60L 2220/42; B60L 2240/12; B60L 2240/421; B60L 2240/423; B60L 2260/28; B60L 2270/142

(57) ABSTRACT

A vehicle system includes: a plurality of drive sources that generate torque for braking and driving a drive wheel of a vehicle; and a control unit that controls the torque. At least one of the drive sources is an electric motor, and the control unit predicts a rotation speed of the electric motor after a current rotation speed, and determines, based on the predicted rotation speed, a start time of shift control for changing the torque to a predetermined torque limit value.

### TECHNICAL FIELD

The present invention relates to a vehicle system.

### BACKGROUND ART

As a background art of the present invention, PTL 1 described below discloses a configuration for controlling a front wheel motor and a rear wheel motor by setting a value smaller in absolute value than basic torque of the front wheel motor to a predetermined torque command and setting a value larger in absolute value than basic torque of the rear wheel motor to a predetermined torque command when a predetermined rotation speed of the front wheel motor or the rear wheel motor is within a resonance region during deceleration in order to suppress a decrease in ride comfort of a driver during the deceleration.

### CITATION LIST

### Patent Literature

PTL 1: JP 2016-93032 A

### SUMMARY OF INVENTION

### Technical Problem

In the configuration of PTL 1, while noise due to regenerative driving of the motor in the resonance region is suppressed, the torque is rapidly changed by switching torque commands of the front wheel motor and the rear wheel motor in a stepwise manner before and after the resonance region, so that shock due to torque fluctuation occurs. The occurrence of shock due to such torque fluctuation is particularly noticeable in high-torque electric vehicles and low-speed conditions.

In view of this, an object of the present invention is to provide a vehicle system that does not cause shock due to torque fluctuation while suppressing noise in a resonance frequency band.

### Solution to Problem

A vehicle system includes: a plurality of drive sources that generate torque for braking and driving a drive wheel of a vehicle; and a control unit that controls the torque. At least one of the drive sources is an electric motor, and the control unit predicts a rotation speed of the electric motor after a current rotation speed, and determines, based on the predicted rotation speed, a start time of shift control for changing the torque to a predetermined torque limit value.

### Advantageous Effects of Invention

According to the present invention, it is possible to provide a vehicle system that does not cause shock due to torque fluctuation while suppressing noise in a resonance frequency band.

### BRIEF DESCRIPTION OF DRAWINGS

FIG. 1 is a block diagram of a vehicle according to an embodiment of the present invention.

FIG. 2 is a block diagram of a vehicle including a vehicle external information acquisition unit in FIG. 1 and a functional block diagram of a control unit in a case where the vehicle external information acquisition unit is included.

FIG. 3 illustrates a modification of FIG. 1.

FIG. 4 illustrates a conventional vehicle system.

FIG. 5 is an explanatory diagram of a vehicle system during deceleration according to an embodiment of the present invention.

FIG. 6 is an explanatory diagram of the vehicle system during acceleration according to the embodiment of the present invention.

FIG. 7 is a functional block diagram of an ECU according to the embodiment of the present invention.

FIG. 8 illustrates an example of a torque limit value map and a control start time map of FIG. 7.

FIG. 9 is a flowchart of the vehicle system according to the embodiment of the present invention.

### DESCRIPTION OF EMBODIMENTS

Hereinafter, embodiments of the present invention will be described with reference to the drawings. The following description and drawings are examples for describing the present invention, and omission and simplification are made as appropriate for the sake of clarity of description. The present invention can be carried out in various other forms. Unless otherwise specified, each component may be singular or plural.

Positions, sizes, shapes, ranges, and the like of components illustrated in the drawings may not represent actual positions, sizes, shapes, ranges, and the like in order to facilitate understanding of the invention. Therefore, the present invention is not necessarily limited to the positions, sizes, shapes, ranges, and the like disclosed in the drawings.

### Embodiment of the Present Invention and Overall Configuration

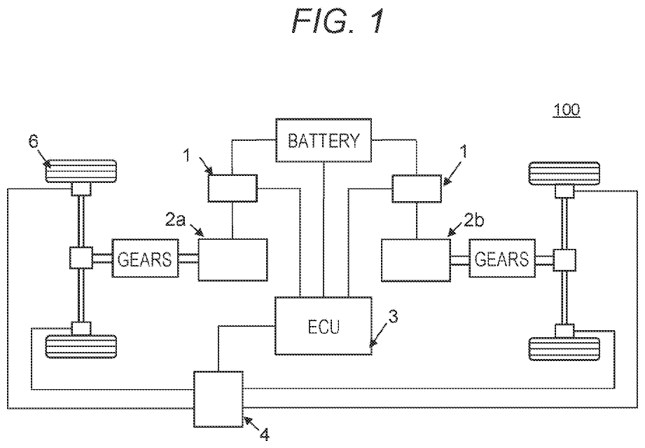

FIG. 1 is a block diagram of a vehicle according to an embodiment of the present invention.

The four-wheel drive electric vehicle 100 includes a battery, an inverter 1, motors 2a and 2b, an ECU 3, a brake actuator 4, gears, and wheels 6. The battery is connected to the inverter 1 and the ECU 3, and supplies direct-current power to each of the inverter 1 and the ECU 3. The inverter 1 is connected to the battery, the motors 2a and 2b, and the ECU 3, converts the supplied direct-current power into alternating-current power, and outputs the alternating-current power to the connected functional units. The motors 2a and 2b are connected to the inverter 1 and the gears, and drive the wheels 6 (front wheels and rear wheels) of the vehicle 100 via the gears. The brake actuator 4 is connected to the ECU 3 and the wheels 6, and brakes the wheels 6 in accordance with a command from the ECU 3.

The ECU 3 is a control unit of the vehicle 100, and performs torque splitting by limiting or compensating for torque of the motors 2a and 2b as described later. Assuming that a traveling direction of the vehicle 100 is a left direction in FIG. 1, the motor 2a is a front wheel side drive source, the motor 2b is a rear wheel side drive source, and the motors 2a and 2b brake and drive the front wheels and the rear wheels, respectively. Although the vehicle 100 includes a plurality of drive sources such as the motors 2a and 2b, at least one of the drive sources may be mounted on the vehicle 100.

The ECU 3 has a function of slowly starting and completing torque limiting when the torque is close to a resonance frequency band by predicting a motor rotation speed after a current rotation speed and estimating the timing (operating point) at which the torque approaches the resonance frequency band from the predicted motor rotation speed. The predicted motor rotation speed is predicted based on a vehicle travel plan created based on, for example, internal information transmitted from an internal sensor that senses a degree of deceleration of the vehicle 100.

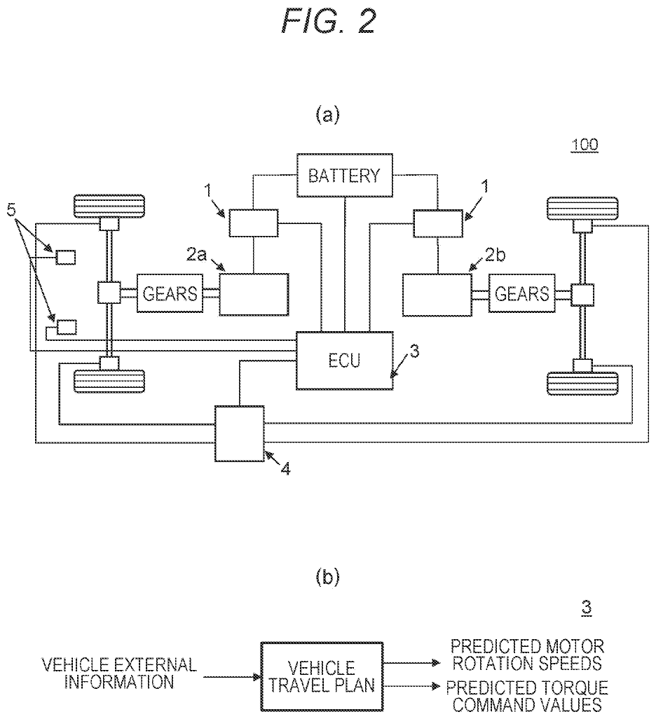

FIG. 2(a) is a block diagram of the vehicle including a vehicle external information acquisition unit in FIG. 1 and FIG. 2(b) is a functional block diagram of a control unit in a case where the vehicle external information acquisition unit is included.

The vehicle external information acquisition unit 5 is a vehicle-mounted device such as a sensor or a camera, and acquires vehicle external information or the like such as information of a preceding vehicle and traffic information obtained from communication with an external. The ECU 3 creates the vehicle travel plan from the acquired vehicle external information, and outputs the predicted motor rotation speed and a predicted torque command value based on the created vehicle travel plan. In this way, how the vehicle 100 travels in the future is determined. Note that the vehicle travel plan is, for example, plan information set by a driver, and is, for example, a motor rotation speed, a torque plan, and the like for maintaining a certain distance from the preceding vehicle.

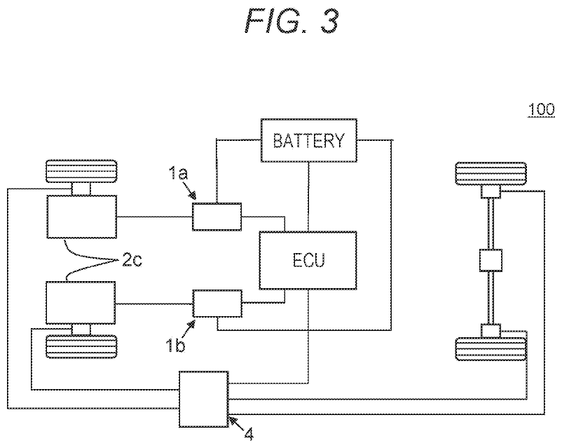

FIG. 3 illustrates a modification of FIG. 1.

Although the vehicle 100 described with reference to FIG. 1 includes a vehicle system for braking and driving the front wheels and the rear wheels, a front wheel drive source 2c may be arranged to brake and drive the front left wheel and the front right wheel, in addition to this configuration. Further, the configuration of the present invention may be applied to left and right wheels of a vehicle in which the left and right sides are independently driven for the front wheels or the rear wheels.

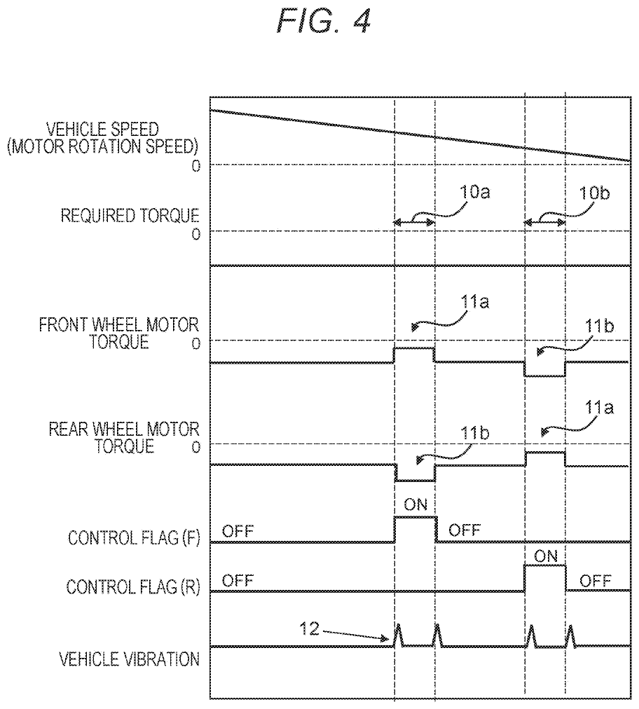

FIG. 4 is a diagram illustrating a state of torque control during deceleration in a conventional vehicle system. In the following description, (F) is attached to functional sections corresponding to the front wheels, and (R) is attached to functional sections corresponding to the rear wheels.

First, a sequence of torque splitting for dividing and distributing torque of front wheels and rear wheels according to a traveling situation will be described. In FIG. 4, resonance regions 10a and 10b represent ranges of rotation speeds at which noise resonance occurs during regenerative driving in motors 2a and 2b. The front wheel motor resonance region 10a for the front wheel motor 2a and the rear wheel motor resonance region 10b for the rear wheel motor 2b are separately set so as not to overlap each other, and these regions are determined according to design specifications of the motors 2a and 2b. As illustrated in FIG. 4, when a control flag (F) for the front wheels is turned on at a timing when the motor rotation speed reaches the front wheel motor resonance region 10a while a vehicle 100 is decelerating, torque limiting 11a is executed on front wheel motor torque (torque of the motor 2a) to reduce the absolute value of the front wheel motor torque. In this case, since the front wheel motor torque has a negative value during the deceleration, the absolute value can be reduced by increasing the value of the front wheel motor torque as illustrated in FIG. 4 when the torque limiting 11a is executed on the motor 2a. Along with this, torque compensation 11b for rear wheel motor torque (torque of the motor 2b) is performed by an amount equivalent to a limited amount of the front wheel motor torque, thereby suppressing a change in driving force of the vehicle 100.

Similarly, when a control flag (R) for the rear wheels is turned on at a timing when the motor rotation speed reaches the rear wheel motor resonance region 10b while the vehicle 100 is decelerating, the torque limiting 11a is executed on the rear wheel motor torque to reduce the absolute value of the rear wheel motor torque. In this case, since the rear wheel motor torque has a negative value during the deceleration, the absolute value can be reduced by increasing the value of the rear wheel motor torque as illustrated in FIG. 4 when the torque limiting 11a is executed on the motor 2b as in the case of the motor 2a. Along with this, the torque compensation 11b for the front wheel motor torque is performed by an amount equivalent to the limited amount of the rear wheel motor torque, thereby suppressing a change in driving force of the vehicle 100.

However, in this conventional system, since the absolute value of the torque drops to a torque limit value at once and changes when the control flag is turned on, shock 12 due to the torque fluctuation occurs and vibration occurs in the vehicle, which causes a problem in ride comfort.

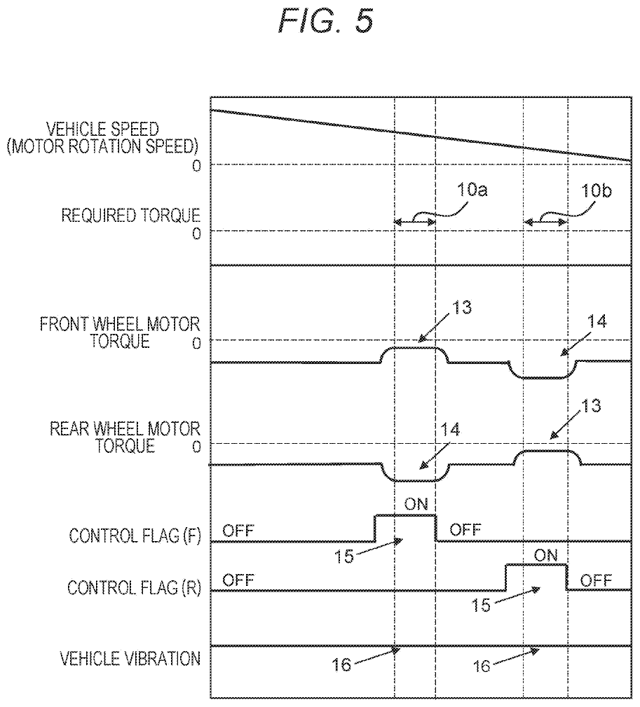

FIG. 5 is an explanatory diagram of the vehicle system during deceleration according to the embodiment of the present invention.

The ECU 3 determines the time until the motor rotation speed reaches a resonance region 10a based on an estimated predicted motor rotation speed for the front wheels while the vehicle 100 is decelerating. As a result, torque limiting 13 is performed at a timing before the timing at which the motor rotation speed reaches the resonance region 10a.

In addition, the ECU 3 performs torque rate limiting, filter processing, and the like on a stepwise torque signal generated based on a current torque command value and a current torque limit value, and calculates split torque that changes gently when rising and falling in the torque limiting. As a result, the torque limiting 13 that is gently started and is gently ended can be implemented. The torque limiting 13 decreases the absolute value of the of the torque to a predetermined torque limit value at which the limit value is maximized in the resonance region 10a. With the torque limiting 13 in the resonance region 10a, the ECU 3 executes torque compensation 14 on the rear wheel motor torque by the same amount as a limit amount in the torque limiting 13 for the front wheel motor torque as a difference amount.

In another resonance region 10b, the torque limiting 13 is performed by the control of the rear wheel motor torque in the same manner as described above, and the torque compensation 14 is performed on the front wheel motor torque by the same amount as the limit amount in the torque limiting 13 for the rear wheel motor torque as a difference amount.

In this way, the torque limiting is started before the timing at which the motor rotation speeds overlap the resonance regions 10a and 10b, and the gentle torque splitting can be implemented. Therefore, it is possible to reliably perform the torque limiting up to the predetermined torque limit value at the timing when the motor rotation speeds overlap the resonance regions 10a and 10b while suppressing the torque from changing suddenly at the start of the torque limiting. As a result, it is possible to implement a state 16 in which the effect of the vibration of the vehicle due to noise occurring in the resonance regions 10a and 10b is reduced without causing shock due to torque fluctuation. Although the control of the ECU 3 has been described on the assumption that torque in the same amount is applied to the front and rear wheels, the ECU 3 can perform similar control even when the amount of torque applied to the front wheels is different from the amount of torque applied to the rear wheels.

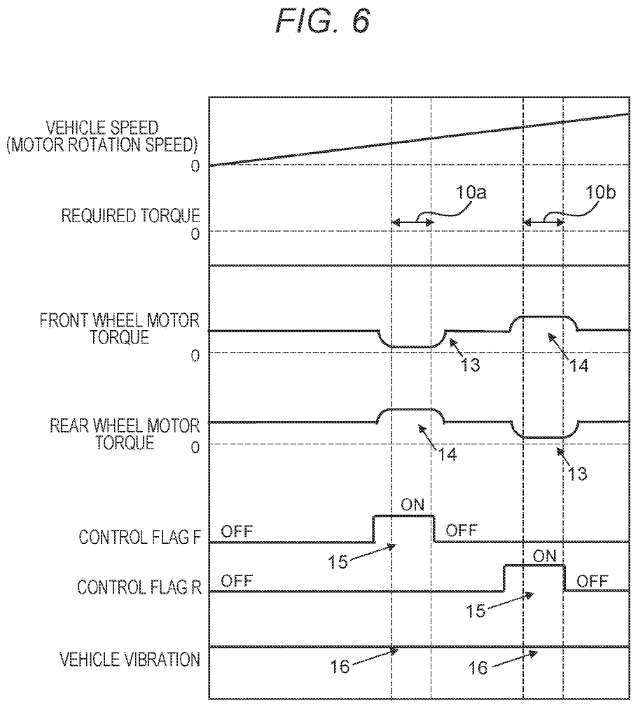

FIG. 6 is an explanatory diagram of the vehicle system during acceleration according to the embodiment of the present invention.

Although the gentle limiting of the torque at the time of deceleration in the vehicle system of the present invention has been described in FIG. 5, even in the case of acceleration as in FIG. 6, it is possible to implement similar gentle torque splitting and to reduce the vibration of the vehicle without causing shock due to a change in torque.

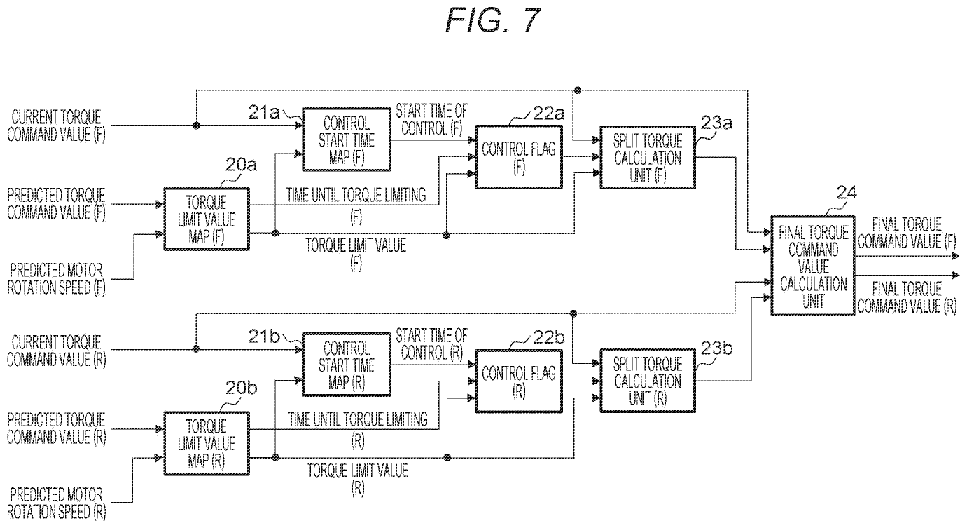

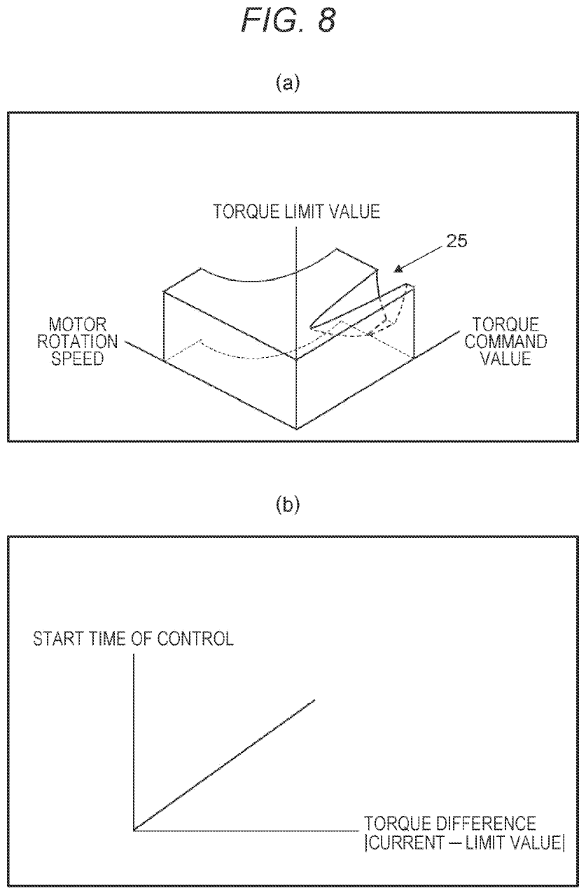

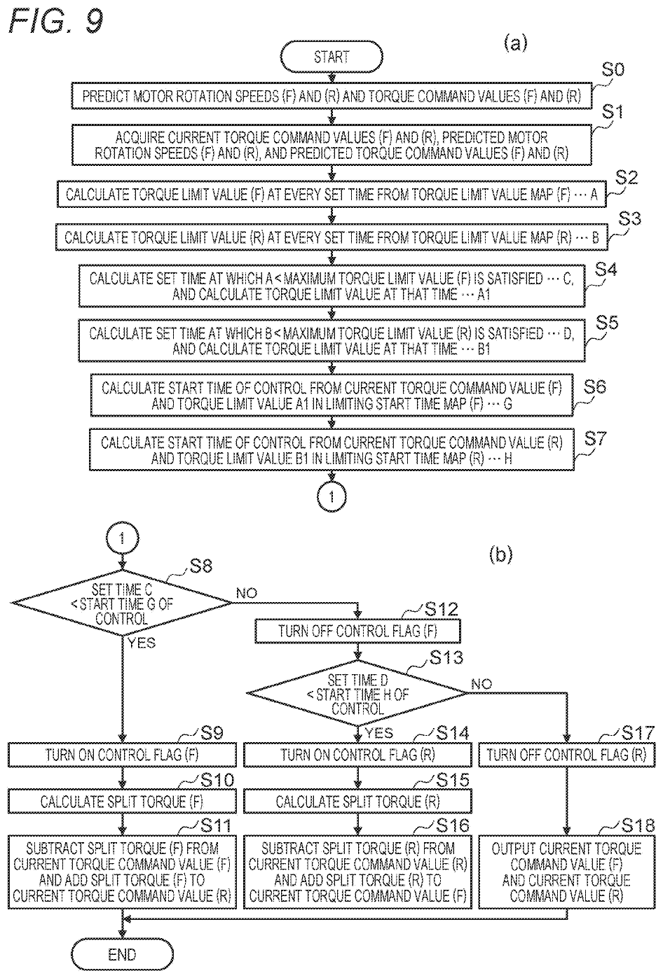

FIG. 7 is a functional block diagram of the ECU according to the embodiment of the present invention. FIG. 8(a) is an example of a torque limit value map of FIG. 7, and FIG. 8(b) is an example of a control start time map of FIG. 7. FIGS. 9(a) and 9(b) are flowcharts of the vehicle system according to the embodiment of the present invention.

The functional block diagram of FIG. 7 will be described. Predicted torque command values (F) and (R) are values obtained based on information such as a future vehicle travel plan. The ECU 3 predicts the torque command values of the motors 2a and 2b after each set time, for example, 50 ms and 100 ms . . . , and stores and updates the prediction results as the predicted torque command values (F) and (R) in a random access memory (RAM) included in the ECU 3.

Similarly, predicted motor rotation speeds (F) and (R) are values obtained based on information such as a future vehicle travel plan. The ECU 3 predicts the motor rotation speeds of the motors 2a and 2b after each set time, for example, 50 ms, 100 ms . . . , and stores and updates the prediction results in the RAM as the predicted motor rotation speeds (F) and (R). Note that 50 ms, 100 ms . . . , and the like, which are the set times, are control constants.

A torque limit value map (F) 20a and a torque limit value map (R) 20b are three-dimensional maps of the motor rotation speeds, the torque command values, and torque limit values. (See FIG. 8(a)) Times (F) and (R) until torque limiting, and the torque limit values (F) and (R) are calculated using the torque limit value map (F) 20a and the torque limit value map (R) 20b based on the predicted torque command value (F) or (R) and the predicted motor rotation speed (F) or (R).

A control start time map (F) 21a and a control start time map (R) 21b determine a start time of torque shift control according to a difference between the torque limit values and the current torque command values (see FIG. 8(b)). Note that the same map may be used in the control start time maps (F) and (R), or different maps may be used in the control start time maps (F) and (R). Although the graph of the control start time map is a straight line as illustrated in FIG. 8(b), the map may be represented by a curve.

A control flag (F) 22a and a control flag (R) 22b are control flags determined based on the start time of the control, the time until the torque limiting, and the torque limit values calculated as described above. The control flag (F) 22a and the control flag (R) 22b are turned on at a timing when the calculated time until the torque limiting is shorter than the calculated start time of the control.

On the other hand, the control flag (F) 22a and the control flag (R) 22b are turned off when the time until the torque limiting is equal to or longer than the start time of the control or when the torque is not limited. When one of the control flag (F) 22a and the control flag (R) 22b is ON, the other flag is OFF.

A split torque calculation unit (F) 23a and a split torque calculation unit (R) 23b generate a rectangular wave from the torque limit values calculated as described above by turning on the control flags 22a and 22b, and perform rate limiting, filter processing, and the like to calculate the split torque. The split torque calculated in this case is a value of a difference between the current torque command value and the torque limit value of the motor on the side closer to the resonance region out of (F) and (R). As a result, the torque limiting corresponding to the difference value calculated from the current torque command value is started at the timing when the control flag is turned on.

Note that the filter processing and the like are assumed to be uniform in terms of control, but this processing may be changed for each control flag.

A final torque command value calculation unit 24 subtracts the split torque value calculated from the current torque command value of the drive source on the side closer to the resonance region from the current torque command value, and adds the split torque to the current torque command value of the other drive source.

Specifically, when the split torque calculated by the split torque calculation unit (F) 23a is input by turning on the control flag (F) 22a, the final torque command value calculation unit 24 subtracts the split torque from the current torque command value (F) described above and adds the split torque to the current torque command value (R) as a compensation amount. When the split torque calculated by the split torque calculation unit (R) 23b is input by turning on the control flag (R) 22b, the final torque command value calculation unit 24 subtracts the split torque from the current torque command value (R) and adds the split torque to the current torque command value (F) as a compensation amount.

In this way, vibration due to a change in driving force of the vehicle can be suppressed. However, in a case where the vibration of the vehicle is within the range of vibration that does not cause a sense of discomfort, the subtracted amounts do not necessarily need to match the added amounts.

A final torque command value (F) is a value obtained by subtracting the split torque (F) from the current torque command value (F) when the control flag (F) is ON in the final torque command value calculation unit 24. A final torque command value (R) is obtained by adding the split torque (R) to the current torque command value (F) when the control flag (R) is ON. When the control flag is OFF, since the values of the split torque output from the split torque calculation unit (F) 23a and the split torque calculation unit (R) 23b are 0, only the current torque command value (F) is output from the final torque command value calculation unit 24.

In this manner, the ECU 3 can determine the timing of the resonance regions from the predicted motor rotation speeds and calculate the final torque command values to be the split torque.

For example, even when at least one of the motors (F) and (R) is a motor, and the other one of the motors (F) and (R) may be another drive source such as an engine, it is possible to implement the present invention.

In addition, since the motors (F) and (R) having different resonance regions are used, torque limiting regions 25 do not overlap each other on the 3D maps of (F) and (R) in the torque limit value maps as illustrated in FIG. 8(a).

Next, a flowchart of FIG. 9 according to the functional block diagram of FIG. 7 will be described. First, in step S0, the motor rotation speeds and the torque command values are predicted, and the predicted motor rotation speeds (F) and (R) and the predicted torque command values (F) and (R) are calculated.

In step S1, the current torque command values (F) and (R), the predicted motor rotation speeds (F) and (R), and the predicted torque command values (F) and (R) are acquired.

In step S2, the torque limit value map (F) calculates the torque limit value (F) at every set time (for example, 50 ms, 100 ms, . . . ) based on the acquired predicted motor rotation speed (F) and the acquired predicted torque command value (F). The calculated torque limit value (F) is defined as A.

In step S3, the torque limit value map (R) calculates the torque limit value (R) at every set time (for example, 50 ms, 100 ms, . . . ) based on the acquired predicted motor rotation speed (R) and the acquired predicted torque command value (R). The calculated torque limit value (R) is defined as B.

In step S4, a set time C at which A< the maximum torque limit value (F) is satisfied is calculated. In addition, a torque limit value A1 at that time is calculated. Similarly, in step S5, a set time D at which B< the maximum torque limit value (R) is satisfied is calculated. In addition, a torque limit value B1 at that time is calculated.

In step S6, in a limiting start time map (F), a start time G of shift control for gradually changing the torque is calculated according to the difference between the current torque command value (F) and the torque limit value A1. As a result, when the torque is changed from the current torque command value (F) to the torque limit value A1, the torque gradually changes according to the difference between the current torque command value (F) and the torque limit value A1.

In step S7, in a limiting start time map (R), a start time H of shift control for gradually changing the torque is calculated according to the difference between the current torque command value (R) and the torque limit value B1. As a result, when the torque is changed from the current torque command value (R) to the torque limit value B1, the torque gradually changes according to the difference between the current torque command value (R) and the torque limit value B1. Note that the limiting start time maps in FIG. 8(b) may be the same or different for (F) and (R).

In step S8, it is determined whether the set time C< the start time G of the control is satisfied. In a case where the determination is YES, the control flag (F) is turned on in step S9 to calculate the torque split. In a case where the determination is NO, the control flag (F) is turned off in step S12, and determination is made on the (R) side.

When the control flag (F) is turned on in step S9, the split torque (F) is calculated in step S10. Specifically, from the timing when the control flag (F) is turned on, a stepwise signal (rectangular wave) is generated based on the current torque command value (F) and the torque limit value A1, rate limiting, filter processing, and the like are performed on the signal, and the split torque (F) that changes gently when rising to the torque limit value and falling to the original torque command value is calculated.

In step S11, the split torque (F) calculated in step S10 is subtracted from the current torque command value (F), and added to the current torque command value (R), and the flowchart is ended. As described above, the final split torque (F) and (R) subtracted and added as described above is reflected as the final torque command value.

When the control flag (F) is turned off in step S12, it is determined in step S13 whether the set time D< the start time H of the control is satisfied. As described above, in a case where NO is determined on the (F) side, the same determination as that on the (F) side is performed also on the (R) side. In a case where the determination is YES, the control flag (R) is turned on in step S14. In a case where the determination is NO, the control flag (R) is turned off in step S17.

When the control flag (R) is turned on in step S14, the split torque (R) is calculated in step S15. The method of calculating the split torque (R) is similar to the method of calculating the split torque (F) in step S10. In step S16, the split torque (R) is subtracted from the current torque command value (R), while the split torque (R) is added to the current torque command value (F), and the flowchart is ended.

When the control flag (R) is turned off in step S17, both the control flags (F) and (R) are off. Therefore, the current torque command values (F) and (R) are output as they are as the final torque command values in step S18, and the flowchart is ended.

In the embodiment described above, the example of the vehicle system including the motor 2a for the front wheels and the motor 2b for the rear wheels as the drive sources that generate the torque for braking and driving the drive wheels of the vehicle 100 has been described, but the present invention is not limited thereto. For example, as in the modification illustrated in FIG. 3, the drive source 2c such as an in-wheel motor may be mounted on each of the left front wheel and the right front wheel of the vehicle 100, or other types of drive sources such as an engine for the front wheels and a motor for the rear wheels may be mounted. Furthermore, for example, torque of a plurality of types of drive sources such as an engine and a motor may be combined and output to the drive wheels. The present invention can be applied to a vehicle system of any form as long as the vehicle system includes a plurality of drive sources and at least one of the drive sources is an electric motor.

In addition, since, in the present invention, the shift control from the highest efficiency of torque for comfort is performed, it affects battery consumption and high heat of the motors. Therefore, it is also possible to determine certain prohibition. For example, when a change in acceleration larger than vehicle vibration caused by torque ripple occurs, the vehicle becomes significantly unstable. Therefore, at this time, since the influence of the ride comfort cannot be reduced even when control of changing a torque distribution is performed, the control may not be performed by determining the prohibition of the control.

In addition, the prohibition of the control of changing the torque distribution may be determined when a condition under which the vehicle becomes unstable or a condition under which a user is likely to feel uncomfortable due to the control is detected. For example, the control of the present invention is not performed in traveling on a low u road surface or a curved road, traveling with sudden start, sudden deceleration, or sudden turn, or the like.

In addition, in a case where the time during which the motor rotation speed is in the resonance region is shorter than the calculated set time and under the condition of sudden acceleration/sudden deceleration, or the like, the influence of the ride comfort cannot be reduced, and thus, the prohibition of the control of changing the torque distribution may be determined.

In addition, there is also a method of determining the prohibition of the control of changing the torque distribution based on information regarding a battery charging rate, and the control may not be performed when the battery charging rate falls below a predetermined set value.

In addition, there is also a method of determining the prohibition of the control of changing the torque distribution based on information regarding the temperatures of the motors, and the control may not be performed when the temperatures of the motors exceed a predetermined set value.

According to the embodiment of the present invention described above, the following operational effects are obtained.

(1) A vehicle system includes a plurality of drive sources that generate torque 11 for braking and driving drive a drive wheel of a vehicle 100, and a control unit 3 that controls the torque. At least one of the drive sources is an electric motor, and the control unit 3 predicts a rotation speed of the electric motor after a current rotation speed, and determines, based on the predicted rotation speed, a start time of shift control for changing the torque to a predetermined torque limit value. With this configuration, it is possible to provide the vehicle system that does not cause shock due to torque fluctuation while suppressing noise in a resonance frequency band.

(2) The vehicle system further includes a vehicle external information acquisition unit 5 that acquires external information of the vehicle 100, and the control unit 3 predicts the rotation speed of the electric motor based on the external information. With this configuration, it is possible to provide the vehicle system that suppresses noise and does not cause shock due to torque fluctuation based on the external information.

(3) The vehicle system starts the shift control before the rotation speed of the electric motor reaches a predetermined resonance region. With this configuration, no shock due to torque fluctuation occurs.

(4) In the vehicle system, the drive sources include a first electric motor and a second electric motor that brake and drive different drive wheels of the vehicle, and a resonance region 10a for the first electric motor and a resonance region 10b for the second electric motor are set so as not to overlap each other. With this configuration, torque splitting corresponding to each of a front wheel and a rear wheel can be performed.

(5) In the vehicle system, the drive sources brake and drive a front wheel and a rear wheel of the vehicle. With this configuration, torque splitting corresponding to each of the front wheel and the rear wheel can be performed.

(6) In the vehicle system, the drive sources brake and drive a left wheel and a right wheel of the vehicle. With this configuration, torque splitting corresponding to each of the left wheel and the right wheel can be performed.

Note that the present invention is not limited to the above embodiments, and various modifications and other configurations can be combined without departing from the gist of the present invention. In addition, the present invention is not limited to one including all the configurations described in the above embodiment, and includes one in which a part of the configurations is removed.

### REFERENCE SIGNS LIST

3 ECU (control unit)
5 vehicle external information acquisition unit
10 resonance region
10a front wheel motor resonance region
10b rear wheel motor resonance region
11 torque
11a torque limiting
11b torque compensation
20a torque limit value map (F)
20b torque limit value map (R)
21a limiting start time map (F)
21b limiting start time map (R)
22a limiting flag (F)
22b limiting flag (R)
23a split torque calculation unit (F)
23b split torque calculation unit (R)
24 final torque command value calculation unit
25 torque limiting region
100 vehicle

1. A vehicle system comprising:
a plurality of drive sources that generate torque for braking and driving a drive wheel of a vehicle; and
a control unit that controls the torque, wherein
at least one of the drive sources is an electric motor, and
the control unit predicts a rotation speed of the electric motor after a current rotation speed, and determines, based on the predicted rotation speed, a start time of shift control for changing the torque to a predetermined torque limit value.

2. The vehicle system according to claim 1, further comprising a vehicle external information acquisition unit that acquires external information of the vehicle, wherein
the control unit predicts the rotation speed of the electric motor based on the external information.

3. The vehicle system according to claim 1, wherein the shift control is started before the rotation speed of the electric motor reaches a predetermined resonance region.

4. The vehicle system according to claim 3, wherein
the drive sources include a first electric motor and a second electric motor that brake and drive different drive wheels of the vehicle, and
the resonance region for the first electric motor and the resonance region for the second electric motor are set so as not to overlap each other.

5. The vehicle system according to claim 1, wherein the drive sources brake and drive a front wheel and a rear wheel of the vehicle.

6. The vehicle system according to claim 1, wherein the drive sources brake and drive a left wheel and a right wheel of the vehicle.
